(19) United States
(12) Patent Application Publication
(10) Pub. No.: US 2010/0112283 A1
(43) Pub. Date: May 6, 2010

(54) PERFORATED COMPOSITE STRUCTURES AND METHODS THEREFORE

(76) Inventors: Graham F. Howarth, Baltimore, MD (US); Katherine M. Rizzo, Baltimore, MD (US); James J. Velten, Baltimore, MD (US)

Correspondence Address: GENERAL ELECTRIC COMPANY, GE AVIATION, ONE NEUMANN WAY MD F16, CINCINNATI, OH, 45215, US

(21) Appl. No.: 12/262,840

(22) Filed: Oct. 31, 2008

(51) Int. Cl. B32B 3/10; B29D 19/08; B32B 38/04

(52) U.S. Cl. 428/137; 264/154; 264/156; 264/482; 264/488; 156/253

(57) ABSTRACT

Method including: (a) forming a laminate structure including a plurality of uncured prepreg sheets, wherein the laminate structure comprises an initial substantially planar configuration; (b) subjecting the laminate structure to suitable first curing conditions to provide a partially cured laminate structure while maintaining the substantially planar configuration; (c) providing the partially cured laminate structure with a plurality of perforations to provide a partially cured and perforated laminate structure; (d) shaping the partially cured and perforated laminate structure; and (e) subjecting the partially cured and perforated laminate structure to second curing conditions at least partially simultaneously with or after step (d) to provide a shaped and finally cured laminate structure.

### BACKGROUND OF THE INVENTION

This invention relates generally to the perforation of composite structures, and more specifically to improved methods for providing perforated acoustic structures particularly for use in aerospace applications or other applications where acoustic treatment of composite structures may be required.

Composite skins for nacelle components, e.g., inlet, thrust reverser cowl, and blocker doors, and engine duct acoustic panels require hundreds of thousands of small diameter holes, approximately 0.030 to 0.080 inches (7.62 mm to 20.32 mm) in diameter, in a precise pattern, and with good geometric quality and tolerances.

The perforations, or holes, may be made by various methods, depending on the application. For example, punching may be used for uncured, thin, usually fiberglass, skins of 1 or 2 plies. Mechanical drilling may be used for cured graphite or fiberglass skins, drilled 1, 2 or 4 holes at a time, in a typical semi-circular cowl skin cured to its finished geometric shape. Flatter skins or structures may be drilled with more holes at a time dependent on skin shape, hole size and tolerance, drill forces, etc. Mechanical drilling of cured skins is extremely slow, uses specialized, expensive equipment, and requires frequent replacement of expensive, specialized drill bit. Pin molding, where uncured laminate sheets are forced onto metallic or non-metallic pin mats prior to cure, and process through to cure, is a conventional method. However, each of these processes present significant problems. For example, punching is not useful for graphite or high strength fiber reinforced composites. Mechanical drilling is extremely slow and uses expensive equipment. Pin molding is slow and labor intensive with significant recurring cost elements. Problems with certain perforation methods are set forth, for example, in U.S. Pat. Nos. 5,268,055 and 5,252,279.

Accordingly, it would be desirable to provide perforated composite structures that avoid the problems encountered in known processes.

### BRIEF DESCRIPTION OF THE INVENTION

The above-mentioned need or needs may be met by exemplary embodiments that provide methods for achieving perforated composite structures having a large quantity of small diameter, high quality holes therein. For example, exemplary embodiments disclosed herein provide acoustic skins for use in aerospace applications as well as industrial, medical, civil and other transport applications where acoustic treatment of composite structures may be required. Exemplary embodiments may also be utilized in composite, aerospace control surfaces (including wing and stabilizer structures) and nacelle applications to provide small modification or laminar flow enhancement.

An exemplary method includes: (a) forming a laminate structure including a plurality of uncured prepreg sheets, wherein the laminate structure comprises an initial substantially planar configuration; (b) subjecting the laminate structure to suitable first curing conditions to provide a partially cured laminate structure while maintaining the substantially planar configuration; (c) providing the partially cured laminate structure with a plurality of perforations to provide a partially cured and perforated laminate structure; (d) shaping the partially cured and perforated laminate structure; and (e) subjecting the partially cured and perforated laminate structure to second curing conditions at least partially simultaneously with or after step (d) to provide a shaped and finally cured laminate structure.

An exemplary embodiment includes an article comprising a shaped and finally cured laminate structure formed by the method described above.

An exemplary method includes: (a) forming a laminate structure including a plurality of uncured prepreg sheets comprising fiber reinforced epoxy resin, wherein the laminate structure comprises an initial substantially planar configuration; (b) subjecting the laminate structure to suitable first curing conditions including heating the laminate structure a temperature below a predetermined final curing temperature to provide a partially cured laminate structure while maintaining the substantially planar configuration; (c) subsequent to (b), cooling the partially cured laminate structure to inhibit further curing of the epoxy resin; (d) subsequent to (c), providing the partially cured laminate structure with a plurality of perforations to provide a partially cured and perforated laminate structure.

An exemplary embodiment includes an article comprising a partially cured and perforated laminate structure by the method described above.

### BRIEF DESCRIPTION OF THE DRAWINGS

The subject matter which is regarded as the invention is particularly pointed out and distinctly claimed in the concluding part of the specification. The invention, however, may be best understood by reference to the following description taken in conjunction with the accompanying drawing figures in which:

FIG. 1 illustrates an exemplary acoustic structure having a plurality of perforations therein.

FIG. 2 provides schematic representations of laminated structures in various conditions.

FIG. 3 provides an exemplary total cure cycle for a laminated structure as disclosed herein.

FIG. 4 is an exemplary process flow chart.

### DETAILED DESCRIPTION OF THE INVENTION

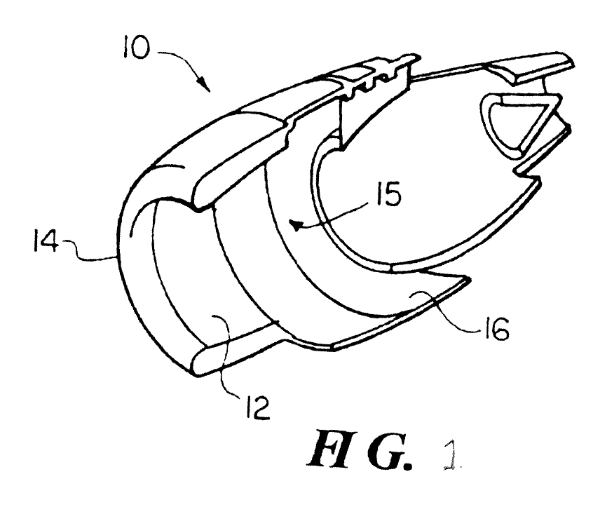

Referring to the drawings wherein identical reference numerals denote the same elements throughout the various views, FIG. 1 shows exemplary acoustic structures in use in a nacelle 10 of a jet aircraft. For example, arcuate inner surface 12 of a nose cowl 14 and the arcuate inner surface 15 of a thrust reverser 16 may include laminate acoustic structures. To achieve the desired acoustic effect, the structure includes laminate composite skins typically from one to ten composite plies thick with holes ranging from about 0.030 to 0.080 inches (7.62 mm to 20.32 mm) diameter and with precise tolerances on hole location, size, geometry, and normalcy to the surface. Although illustrated in connection with an aircraft nacelle, other acoustic structures are contemplated within the scope of this invention. Such other acoustic structures may require different numbers of composite plies or size and arrangement of holes as can be appreciated by those skilled in the art.

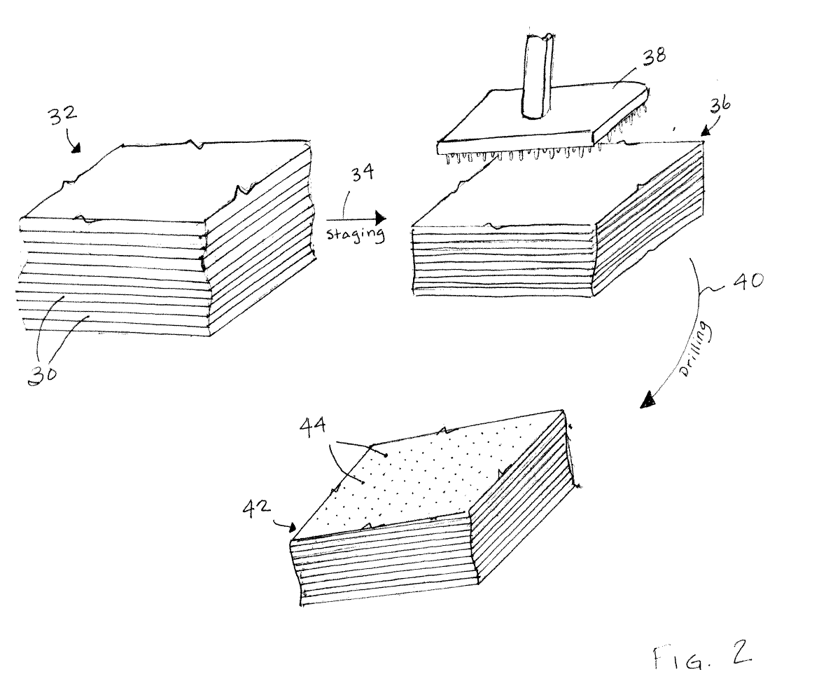

Embodiments disclosed herein utilize composite pre-impregnated sheets, particularly a graphite material impregnated with epoxy (pre-preg), although other resin systems such as bismaleimide are contemplated. As illustrated in FIG. 2, a plurality of pre-preg sheets 30 are arranged into a laminate structure 32 in a prearranged manner, as is known in the art. Initially, the laminate structure 32 comprises a substantially planar configuration.

In an exemplary embodiment, the laminate structure 32 is subjected to a “staging” or partial cure operation, indicated by arrow 34. The staged or partially cured laminate structure 36 is then subjected to a perforating operation. A drill 38 or other implement may be utilized to perforate the partially cured laminate structure 36, as indicated by arrow 40, with the desired number of holes 44. The perforations may be created by drilling, punching, or other rapid machining process using conventional machine tools. The machining tool may include single or multiple machine heads configured with multiple pins or drills. In an exemplary embodiment the planar, partially cured laminate structure is drilled with a machine drill head incorporating sixty-four drills operating simultaneously. Other exemplary embodiments may include more or less simultaneously operating drills dependent on drill size, hole proximity, laminate thickness, resin type, and machine capability. Other exemplary embodiments include drilling of multiple partially cured laminated skins, i.e., several skins each comprised of multiple plies. The number of laminated skins able to be simultaneously drilled is dependent on resin type, fiber reinforcement type and weave, drill size, laminate per ply thickness, and ply quantity. The perforated, partially cured laminate structure 42 is thereafter shaped and finally cured.

Several factors impact the extent to which the laminate structure is partially cured. Some of the factors include an evaluation of structural material properties in the laminate structure resulting from a partial cure followed by a final cure, the ability of the holes to stay open and fully formed curing the final cure, the formability of the laminate structure during the final cure, and the like. The laminate structure may be partially cured using an autoclave, oven, heated press, or other suitable apparatus known to those with skill in the pertinent art.

Once established, the partial cure parameters (e.g., pressure, temperature, time) are incorporated into the overall composite processing requirements. Of course, those will skill in the art will appreciate that the partial cure parameters may be optimized at different values based on such factors as resin type, hole size, fiber reinforcement type and weave, laminate thickness, and the like.

In an exemplary embodiment, the perforated, partially cured laminate structure is then placed into a mold for forming and subjected to final cure conditions. The final cure may be achieved by any conventional means known in the art such as use of an autoclave, oven, or press with appropriate temperature, vacuum, and/or pressure. In an exemplary embodiment, the partially cured laminate structure retains enough pliability to take the shape of the mold, yet still yield acceptable structural mechanical properties after final cure. In an exemplary embodiment, the shaped laminate structure is cured to a final configuration under suitable cure conditions. The shaped and finally cured laminate structure is utilized for structural and/or acoustic applications. In other exemplary embodiments, the perforated, partially cured laminate structure may be shaped, molded, or otherwise formed at temperatures less than the final cure temperature. After shaping, the shaped/perforated/partially cured laminate structure may be subjected to cold storage before a subsequent final cure cycle.

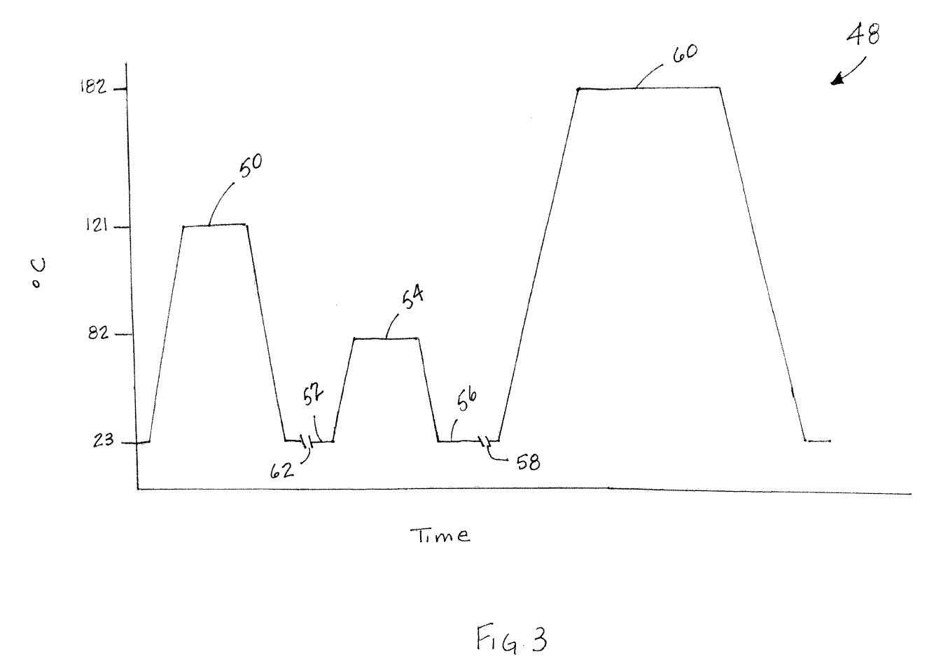

An exemplary total cure cycle 48, including the partial cure, is illustrated in FIG. 3, wherein the prepreg material comprises fiber reinforcement material in an epoxy resin. As shown, the initial laminate structure undergoes “staging” or a partial cure step illustrated by curve 50. The perforating step is illustrated by line 52. A shaping or forming step is illustrated by curve 54. The shaping or forming step may be followed by a time lag, illustrated by gap 58 in line 56. The final cure cycle is illustrated by curve 60. In an exemplary embodiment, the staging step may be followed by a time lag as illustrated by gap 62 in line 56. In an exemplary cure cycle 48, the heat ramps may be at a rate of about 1.5° F./min (0.8° C./min). In an exemplary cure cycle, curve 50 may include a hold time of about 60 minutes, curve 54 may include a hold time of about 45-60 minutes, and curve 60 may include a hold time of about 120 minutes. In an exemplary embodiment, the time lags illustrated by gap 58 and gap 62 in FIG. 3 may include cold storage at a temperature able to inhibit further reaction of the resin system. The illustrated total cure cycle 48 is provided in an exemplary manner only. Other cure cycles are contemplated within the scope of the invention. Those with skill in the art will appreciate that the initial laminate structure may also be placed in cold storage prior to subjecting the laminate structure to the partial cure conditions.

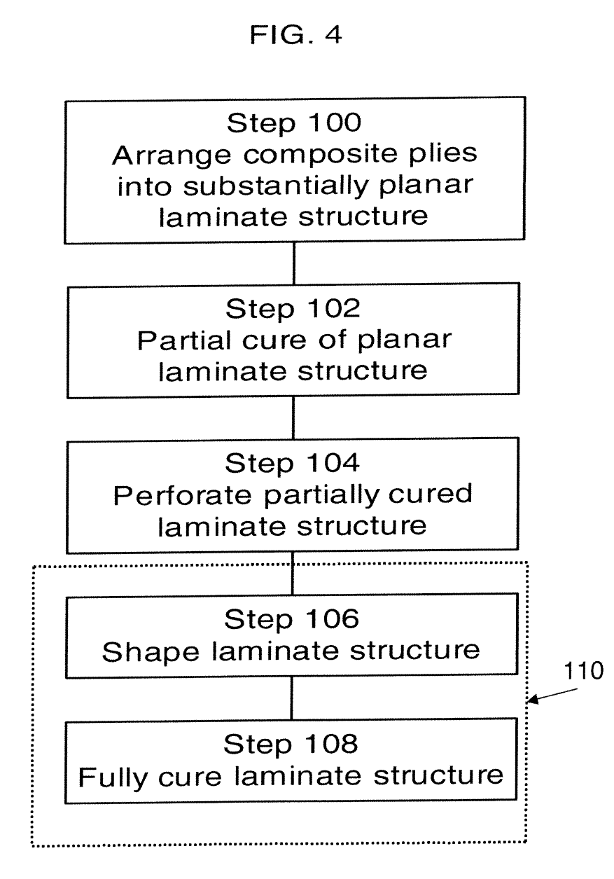

FIG. 4 provides a flow chart of an exemplary method as disclosed herein. An exemplary method includes arranging uncured composite plies into a substantially planar laminate structure (Step 100). The planar laminate structure is partially cured (staged) (Step 102). The laminate structure is then perforated by drilling or other perforation methods while still in a substantially planar condition (Step 104). The partially-cured/perforated laminate structure is shaped (Step 106) and finally cured (Step 108). In certain exemplary embodiments, Step 106 and Step 108 may occur at least partially simultaneously, in a mold, autoclave, or other curing device, as depicted by the dotted box 110 in FIG. 4. In other exemplary embodiments, Step 106 and Step 108 may occur sequentially. It is envisioned that those with skill in the art will appreciate that there may be a time lag between Step 102 and Step 104, and between Step 106 and Step 108 of up to about 24 hours subject to cold storage of the partially cured laminate structure. The possible time lags are illustrated by gaps 58, 62 in FIG. 3. Exemplary perforating processes include mechanical drilling, punching, laser drilling, electron beam drilling and the like.

During the final cure, the holes substantially retain their close-toleranced drilled or punched shape and entry/exit geometry. In other words, round holes remain substantially round. Slight and predictable shrinkage of the hole diameter occurs, dependent upon the flow characteristics of the resin yet to be cured in the final cure. The slight flow can be beneficial in that it seals or covers the fibrous ends of the reinforcement material exposed during the drilling operation. Thus, subsequent fluid ingress or absorption during service may be reduced or eliminated.

The exemplary methods disclosed herein may be practiced with fiberglass and graphite/epoxy composite materials, bismaleimide/fiberglass, bismaleimide/fiberglass composite materials, and other fiber reinforcements, both continuous and non-continuous such as nylon, Kevlar®, and the like.

Exemplary methods disclosed herein are not limited to the composite structures discussed above. The principles taught herein may be expanded for use with fiber reinforced thermoplastic resins or consolidated fiber/thermoplastic sheet materials using PPS, PEK, PEEK and other resins. For example, multiple small diameter acoustic holes may be formed when the reinforced thermoplastic material is in a planar state prior to shaping and curing to a final formed state.

It is envisioned that embodiments disclosed herein may be particularly useful for forming microperforated composite structures for improved acoustic effects and improvements to laminar flow over aerodynamic surfaces. The hole diameters for microperforates may be about 0.005 inch (about 13 mm).

Thus, exemplary embodiments disclosed herein provide methods for forming perforated composite structures that avoid the problems heretofore encountered in the art by partially curing the laminate structure (staging), perforating the partially cured laminate structure (e.g., drilling), shaping the partially cured laminate structure (molding), and finally curing the laminate structure.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. Method including:
a) forming a laminate structure including a plurality of uncured prepreg sheets, wherein the laminate structure comprises an initial substantially planar configuration;
b) subjecting the laminate structure to suitable first curing conditions to provide a partially cured laminate structure while maintaining the substantially planar configuration;
c) providing the partially cured laminate structure with a plurality of perforations to provide a partially cured and perforated laminate structure;
d) shaping the partially cured and perforated laminate structure; and
e) subjecting the partially cured and perforated laminate structure to second curing conditions at least partially simultaneously with or after step (d) to provide a shaped and finally cured laminate structure.

2. The method according to claim 1 wherein the partially cured and perforated laminate structure is subjected to the second curing conditions after step (d).

3. The method according to claim 1 wherein in step (c), providing the partially cured laminate structure with the plurality of perforations includes utilizing at least one process selected from: a mechanical drilling process, a punching process, a laser drilling process, an electron beam drilling process.

4. The method according to claim 1 wherein in (a) forming a laminate structure includes utilizing prepreg sheets comprising at least one member selected from: fiber reinforced epoxy resin, fiberglass and graphite reinforced epoxy resin, fiberglass reinforced bismaleimide resin, fiber reinforced thermoplastic resin, and fiber reinforced epoxy resin.

5. The method according to claim 1 wherein at least one of step (b) and step (d) is followed by a time lag at a temperature able to inhibit further curing.

6. An article comprising the shaped and finally cured laminate structure formed by the method according to claim 1.

7. The article according to claim 6 comprising an acoustic structure for an aircraft nacelle.

8. The article according to claim 6 having an arcuate shape.

9. The article according to claim 6 wherein the perforations are substantially round.

10. The article according to claim 9 wherein the perforations each have a diameter of about 0.030 to 0.080 inches (about 7.62 mm to 20.32 mm).

11. The article according to claim 9 wherein the perforation each have a diameter of about 0.005 inch (about 0.13 mm).

12. A method comprising:
a) forming a laminate structure including a plurality of uncured prepreg sheets comprising fiber reinforced epoxy resin, wherein the laminate structure comprises an initial substantially planar configuration;
b) subjecting the laminate structure to suitable first curing conditions including heating the laminate structure a temperature below a predetermined final curing temperature to provide a partially cured laminate structure while maintaining the substantially planar configuration;
c) subsequent to (b), cooling the partially cured laminate structure to inhibit further curing of the epoxy resin;
d) subsequent to (c), providing the partially cured laminate structure with a plurality of perforations to provide a partially cured and perforated laminate structure.

13. An article comprising a partially cured and perforated laminate structure formed by the method according to claim 12.
